(19) United States
(12) Patent Application Publication
(10) Pub. No.: US 2020/0158524 A1
(43) Pub. Date: May 21, 2020

(54) CARPOOL SERVICE SYSTEM AND CARPOOL SERVICE METHOD

(71) Applicants: HYUNDAI MOTOR COMPANY, Seoul (KR); KIA MOTORS CORPORATION, Seoul (KR)

(72) Inventors: Se Joon JOO, Seoul (KR); Tae Won KIM, Seoul (KR); Moo Shin RHEE, Seoul (KR); Ji Soo KIM, Seoul (KR)

(21) Appl. No.: 16/515,181

(22) Filed: Jul. 18, 2019

(30) Foreign Application Priority Data
Nov. 20, 2018 (KR) 10-2018-0143878

(51) Int. Cl. G01C 21/34; G06Q 10/02; G06Q 50/30

(52) U.S. Cl. CPC G01C 21/3438; G06Q 50/30; G06Q 10/02

(57) ABSTRACT

A carpool service system includes a service providing device which is configured to: receive carpool service requesting information from a user terminal; generate at least two routes based on the carpool service requesting information;

and providing a carpool partner matching based on location information about each of the at least two routes and about each of one or more preregistered user routes.

### CROSS-REFERENCE TO RELATED APPLICATION

This application claims the benefit of priority to Korean Patent Application No. 10-2018-0143878, filed in the Korean Intellectual Property Office on Nov. 20, 2018, the entire contents of which are incorporated herein by reference.

### TECHNICAL FIELD

The present disclosure relates to a carpool service system and a carpool service method.

### BACKGROUND

Carpooling is sharing a vehicle for people with the same destination or the same traveling route to help reduce traveling cost and traffic congestion. As the number of users carpooling has increased, a service for matching a carpool provider (e.g. a vehicle) and a carpool user has been made available.

When a carpool provider registers carpool provider information, including a starting point, departure time, and a destination, on a server for providing a carpool matching service, and when a carpool requestor inputs information such as a starting point, departure time, and a destination, the carpool matching service matches the carpool provider and carpool requestor based on the above information.

### SUMMARY

The present disclosure has been made to solve the above-mentioned problems occurring in the prior art while advantages achieved by the prior art are maintained intact.

An aspect of the present disclosure provides a carpool service system and a carpool service method that compare routes of a driver and a rider, and provides carpool partner lists to the driver and the rider based on a matching percentage.

The technical problems to be solved by the present disclosure are not limited to the aforementioned problems, and any other technical problems not mentioned herein will be clearly understood from the following description by those skilled in the art to which the present disclosure pertains.

According to one exemplary embodiment of the present disclosure, a carpool service system includes a service providing device configured to: receive carpool service requesting information from a user terminal; generate at least two routes based on the carpool service requesting information; and provide a carpool partner matching based on a first location information about each of the at least two routes and a second location information about each of one or more preregistered user routes.

The carpool service requesting information may include a starting point, a destination, and a carpool service use time.

The service providing device may generate the at least two routes including at least one of an optimum route, a shortest-distance route, or a minimum-time route between the starting point and the destination.

The service providing device may acquire mathematical location information of a specific location on each of the generated routes.

The specific location may include an intersection, an interchange, or a curved section.

The mathematical location information may include latitude and longitude coordinates.

The service providing device may extract a section where latitude and longitude coordinates of each of the generated routes and latitude and longitude coordinates of each preregistered user route match with each other, and calculate a length of the extracted section.

The service providing device may calculate a ratio of the length of the extracted section to a total length of each of the generated routes as a matching percentage.

The service providing device may calculate a ratio of the length of the extracted section to a total length of each preregistered user route as a matching percentage.

The service providing device may generate a carpool partner list based on the calculated matching percentage, and transmits the carpool partner list to the user terminal.

In the generation of the carpool partner list, the service providing device may generate a pair of a carpool service applicant-based matching percentage and a carpool partner-based matching percentage.

When the service providing device provides the carpool partner matching, the service providing device may match a rider and a driver as a carpool partner, wherein each of proximity percentages between starting points of the driver and the rider and between destinations of the driver and the rider is the highest.

The service providing device may estimate a demand to each route, select a predetermined number of routes of the carpool service applicant and the preregistered user respectively based on the demand, and perform the carpool partner matching based on the predetermined number of routes.

According to another exemplary embodiment of the present disclosure, a carpool service method includes: receiving carpool service requesting information from a user terminal, generating at least two routes based on the carpool service requesting information, acquiring a first location information of each of the at least two routes, calculating a matching percentage between routes of a carpool service applicant and each of one or more preregistered users using the first location information of each of the at least two routes and a second location information of a route of each of the one or more preregistered users, and transmitting, to the user terminal, a carpool partner matching result based on the matching percentage.

The carpool service requesting information may include a starting point, a destination, and carpool service use time.

The generating of the at least two routes may include generating the at least two routes including at least one of an optimum route, a shortest-distance route, and a minimum-time route between the starting point and the destination.

The acquiring of the mathematical location information may include acquiring mathematical location information of a specific location on each of the routes, and calculating a distance between adjacent specific locations based on the mathematical location information.

The specific location may include an intersection, an interchange, or a curved section.

The mathematical location information may include latitude and longitude coordinates.

The calculating of the matching percentage may include extracting a section where the latitude and longitude coordinates of each of the generated routes and latitude and longitude coordinates of the route of each preregistered user match with each other, and calculating a length of the extracted section.

The calculating of the matching percentage may include calculating a ratio of the length of the extracted section to a total length of each of the generated routes as a matching percentage.

The calculating of the matching percentage may include calculating a ratio of the length of the extracted section to a total length of the route of each preregistered user as a matching percentage.

The transmitting of the carpool partner matching result to the user terminal may include generating a carpool partner list based on the calculated matching percentage, and transmitting the carpool partner list to the user terminal.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a carpool service system according to an exemplary embodiment of the present disclosure;

FIG. 2 is a diagram illustrating a service providing device shown in FIG. 1;

FIG. 3 is a diagram for explaining a matching percentage calculation method according to an exemplary embodiment of the present disclosure;

FIG. 4 is a flowchart showing a carpool service method according to an exemplary embodiment of the present disclosure;

FIG. 5 and FIG. 6 show another example of a method for calculating a matching percentage according to an exemplary embodiment of the present disclosure; and

FIG. 7 shows an example of displaying a carpool partner matching result according to an exemplary embodiment of the present disclosure.

### DETAILED DESCRIPTION

Hereinafter, exemplary embodiments of the present disclosure will be described in detail with reference to the accompanying drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure is directed to generating at least two routes of each driver and rider wishing to use a carpool service, calculating a distance between adjacent specific locations based on latitude and longitude coordinates of each of the specific locations of the generated routes, calculating a ratio of a length of an overlapped section of the driver and the rider to a total length of each of the generated routes of the driver and the rider as a matching percentage, and providing, respectively to the driver and the rider, a carpool partner list based on the matching percentage.

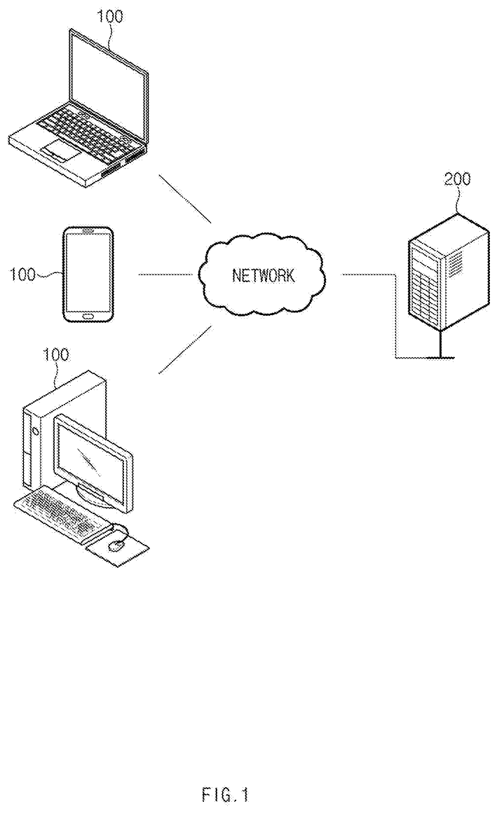

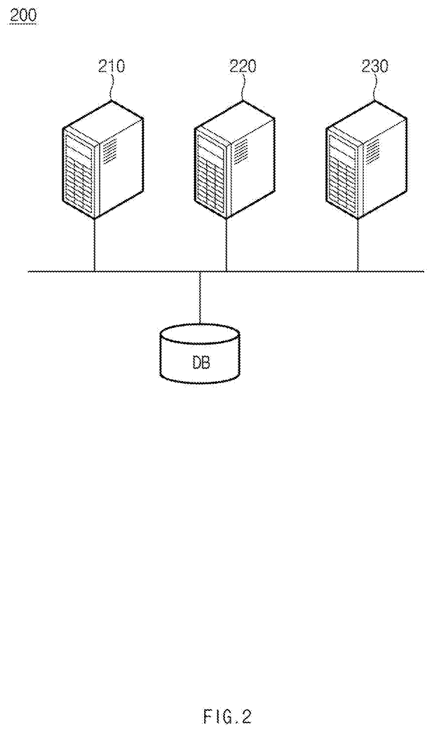

FIG. 1 is a diagram illustrating a carpool service system according to an exemplary embodiment of the present disclosure. FIG. 2 is a diagram illustrating a service providing device shown in FIG. 1.

A carpool service system includes a user terminal 100 and a service providing device 200, which are connected via a network. In this connection, the network may be implemented in a wireless internet network such as a Wireless LAN (WLAN) (WiFi), a wireless broadband (Wibro) and/or a World Interoperability for Microwave Access (Wimax), a mobile communication network such as a Code Division Multiple Access (CDMA), a Global System for Mobile communication (GSM), a Long Term Evolution (LTE) and/or a LTE-Advanced and/or a wired internet network such as a Local Area Network (LAN), a Wide Area Network (WAN), an Ethernet and/or an Integrated Services Digital Network (ISDN).

The user terminal 100 is an electronic device capable of wireless and/or wired communication, which is owned by a driver and/or a rider who wants to use a carpool service. The user terminal 100 may be implemented as a device such as a smart phone, a tablet, a Personal Digital Assistant (PDA), a Portable Multimedia Player (PMP), a Personal Computer (PC) and/or a laptop computer.

This user terminal 100 includes a communication module, a user input module (e.g., a touch pad, a keyboard and/or a touch screen), an output module (e.g., a display and/or a speaker), a processor, and a memory, though not shown in the figures. In this connection, the processor may be implemented as at least one of an Application Specific Integrated Circuit (ASIC), a Digital Signal Processor (DSP), Programmable Logic Devices (PLDs), Field Programmable Gate Arrays (FPGAs), a Central Processing Unit (CPU), microcontrollers, and microprocessors. The memory may be implemented as at least one of a storage medium (recording medium) such as a flash memory, a hard disk, a Secure Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disk, web storage, and the like.

The user terminal 100 receives carpool service requesting information from the driver (a carpool provider) and/or the rider (a carpool requestor), which is a user wishing to use the carpool service, and transmits the carpool service requesting information to the service providing device 200. The carpool service requesting information is divided into carpool offer information and carpool request information. The carpool offer information may include information such as a starting point, a destination, carpool service use time (arrival time), a preference, a type of possessed vehicle, a driver information, and the like, input by the driver. The carpool request information is information input by the rider and may include a starting point, a destination, carpool service use time (arrival time), a preference, and the like.

The service providing device 200 receives the carpool service requesting information transmitted from the user terminal 100. The service providing device 200 determines whether the user applying the carpool service is the driver or the rider. The service providing device 200 performs a rider matching based on the carpool offer information when the service applicant is the driver. In one example, the service providing device 200 performs a driver matching based on the carpool request information when the service applicant is the rider.

This service providing device 200 includes a first server 210, a second server 220, a third server 230, and a database (DB) as shown in FIG. 2.

The first server 210 is a web server that provides a web page to the user terminal 100 via a web. The first server 210 transmits the carpool service requesting information (e.g., the starting point, the destination, the carpool service use time, and the like) input on the web page to the second server 220. For example, when the driver or the rider accesses the web page provided by the first server 210 through the user terminal 100, and inputs the carpool service requesting information, the first server 210 receives the carpool service requesting information input by the user terminal 100.

The second server 220 is a web application server (WAS) that provides an application execution environment, a database access function, and the like. The second server 220 includes an application program interface (API) that supports a navigation service. In other words, the API allows the second server 220 to be interlocked with the navigation service.

The second server 220 interlocks with the navigation service to generate at least two routes based on the carpool service requesting information. The second server 220 may generate various routes using well-known route generation techniques in addition to an optimum route, a shortest-distance route, and a minimum-time route. In this connection, the optimum route refers to a route that is generated considering a distance, time, a traffic situation, a cost, and a fuel efficiency.

In addition, the second server 220 acquires mathematical location information on the route generated using the navigation service. In this connection, the second server 220 obtains mathematical location information of a specific location on the generated route. In this connection, the specific location may include a unit point, an intersection, an interchange, or a curved section. The mathematical location information includes latitude and longitude coordinates.

The second server 220 calculates a distance between adjacent specific locations based on the acquired mathematical location information. In other words, the second server 220 calculates a distance between latitude/longitude coordinates. The second server 220 may calculate a total length of the generated route using the calculated distance between the specific locations.

The second server 220 may store the mathematical location information of each of the routes and length information calculated using the mathematical location information in a database (DB).

The database (DB) stores and manages carpool offer information for each driver, at least one driver route, mathematical location information, and length information of each of the routes. In addition, the database (DB) stores carpool request information for each rider, at least one rider route, mathematical location information and length information of each of the routes.

The third server 230 is a server that processes a carpool matching logic. The third server 230 performs a carpool matching of the driver and the rider with reference to the DB, and provides a carpool matching result to the driver and the rider, respectively.

More specifically, the third server 230 selects a driver and a rider whose carpool service use times match within a predetermined permissible range based on the carpool service use time information in the carpool service requesting information of the driver and rider stored in the DB. For example, when the arrival time in the driver's carpool service requesting information is 8:40 am, the third server 230 selects rider(s) whose arrival time is 8:20 am to 9:00 am from the DB.

The third server 230 compares the route of the driver stored in the DB with the route of the rider, extracts an overlapped section where the mathematical location is matched, and calculates a length of the extracted overlapped section. In other words, the third server 230 extracts the section where the latitude/longitude coordinates of the driver route and the rider route match (overlap), and calculates the length of the corresponding section.

In this connection, the third server 230 may predict a demand for each route (the driver route, the rider route), and select a predetermined number of driver routes and rider routes to be used for a route matching in descending order. The third server 230 may predict the demand for each route based on customer location data provided from a mobile carrier.

The third server 230 calculates a ratio of the length of the overlapped section to a total length of the driver route as a first matching percentage. In addition, the third server 230 calculates a ratio of the length of the overlapped section to a total length of the rider route as a second matching percentage.

The third server 230 selects at least one carpool partner based on the calculated matching percentage, and generates a list of the selected carpool partners. In this connection, the third server 230 generates the carpool partner list based on a matching percentage, and selects the carpool partner based on a predetermined condition (e.g. top 10% matching percentage, and the like). The third server 230 transmits the generated carpool partner list to the user terminal 100.

The third server 230 selects at least one rider as the carpool partner based on the calculated first matching percentage, and generates a selected rider list, and provides the rider list to the driver terminal 100. The third server 230 selects at least one driver as the carpool partner based on the calculated second matching percentage, and generates a selected driver list, and transmits the selected driver list to the rider terminal 100.

The first server 210, the second server 220, and the third server 230 may respectively include a communication module, a processor, and a memory. In this connection, the communication module supports wired/wireless communication between the servers (210 to 230) and/or between the first server 210 and the user terminal 100. The processor may be implemented with at least one of an ASIC, a DSP, a PLD, FPGAs, a CPU, a microcontroller, and a microprocessor. The memory may be implemented with at least one of storage medium such as a flash memory, a hard disk, a RAM, a ROM, a SRAM, a PROM, an EEPROM, an EPROM, a register, and the like.

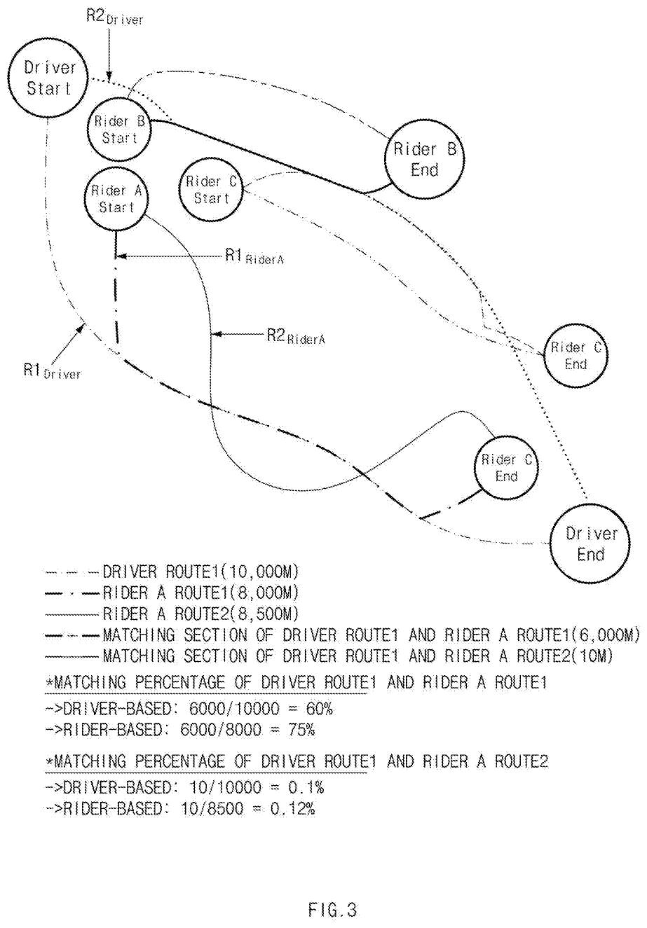

FIG. 3 is a diagram for explaining a matching percentage calculation method according to the present disclosure.

With reference to FIG. 3, the service providing device 200 generates a first driver route (R1_{Driver}) and a second driver route (R2_{Driver}) based on the information about the starting point and the destination included in the carpool offer information provided from the driver terminal 100. For example, the service providing device 200 generates an optimum route and a shortest-distance route between the starting point and the destination.

The service providing device 200 acquires latitude/longitude coordinates for each driver route (R1_{Driver} and R2_{Driver}) generated using the navigation service. The service providing device 200 calculates a distance between the obtained adjacent coordinates, and calculates a total length for each driver route (R1_{Driver} and R2_{Driver}).

The service providing device 200 receives carpool request information respectively from user terminal 100 of a rider A, a rider B, and a rider C. The service providing device 200 generates a first route (R1_{RiderA}, R1_{RiderB}, R1_{RiderC}) and a second route (R2_{RiderA}, R2_{RiderB}, R2_{RiderC}) for each rider respectively using the information about the starting point and the destination included in the carpool request information for each rider.

The service providing device 200 acquires entire latitude and longitude coordinates of the generated rider route (R1_{RiderA}, R1_{RiderB}, R1_{RiderC}, R2_{RiderA}, R2_{RiderB}, R2_{RiderC}) , calculates a distance between the obtained coordinates, and calculates a total length for each rider route (R1_{RiderA}, R1_{RiderB}, R1_{RiderC}, R2_{RiderA}, R2_{RiderB}, R2_{RiderC}).

The service providing device 200 compares the driver route with the rider route, extracts a section with latitude and longitude coordinates that match, and calculates a length of the extracted section.

The service providing device 200 calculates a matching percentage of the rider route to the driver route and a matching percentage of the driver route to the rider route. When there is a section where ranges of travel times and route latitude/longitude coordinates match, the service providing device 200 calculates a matching percentage (=length of matching section route/total travel length of user×100).

For example, a total length of the first driver route (R1_{Driver}) the first route (R1_{RiderA}) and the second route (R2_{RiderA}) of the rider A are respectively 10,000 m, 8,000 m, and 8,500 m, a matching section of the first driver route (R1_{Driver}) and the rider A's first route (R1_{RiderA}) is 6,000 m, and a matching section of the first driver route (R1_{Driver}) and the rider A's second route (R2_{RiderA}) is 10 m, a matching percentage with the rider A's first route (R1_{RiderA}) with reference to the first driver route (R1_{Driver}) is 60% (=6000/10000×100), and a matching percentage with the rider A's second route (R2_{RiderA}) with reference to the first driver route (R1_{Driver}) is 0.1% (=10/10000×100). In one example, a matching percentage of the first driver route (R1_{Driver}) to the rider A's first route (R1_{RiderA}) with reference to the rider A is 75% (=6000/8000×100), and a matching percentage of the first driver route (R1_{Driver}) to the rider A's second route (R2_{RiderA}) with reference to the rider A is 0.12% (=10/8500×100).

The service providing device 200 may provide the calculated result to the driver and the rider, respectively. That is, the service providing device 200 transmits the calculated result to the user terminal 100 of the driver and the rider, respectively.

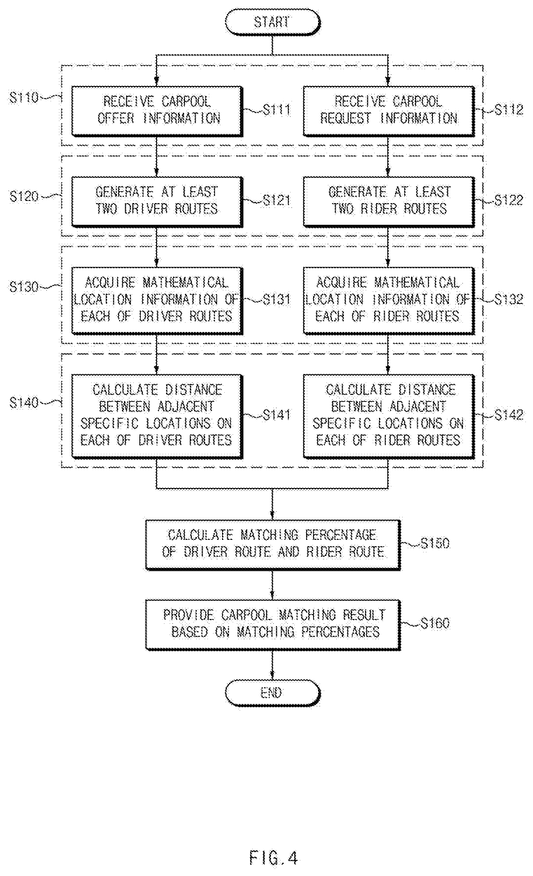

FIG. 4 is a flowchart showing a carpool service method according to an embodiment of the present disclosure.

With reference to FIG. 4, the service providing device 200 receives the carpool service requesting information from the user terminal 100 (S110). The service providing device 200 receives the carpool offer information from the driver terminal 100 (S111), and receives the carpool request information from the rider terminal 100 (S112). In this connection, the carpool offer information and the carpool request information include information on the starting point, the destination, the carpool service use time (e.g., the arrival time), and the like.

The service providing device 200 generates the at least two travel routes (hereinafter referred to as the route) of the carpool service applicant based on the carpool service requesting information (S120). The service providing device 200 is interlocked with the navigation service to generate the at least two routes to reach the destination from the starting point. In other words, the service providing device 200 generates the at least two driver routes based on the carpool offer information (S121). In addition, the service providing device 200 generates the at least two rider routes based on the carpool request information (S122).

The service providing device 200 acquires the mathematical location information for each generated route (S130). The service providing device 200 acquires the mathematical location information of each of the driver routes generated using the navigation service (S131). The service providing device 200 acquires the mathematical location information of each of the generated rider routes (S132). In this connection, the service providing device 200 obtains the mathematical location information of the specific location on the route. In this connection, the specific location includes the unit point, the intersection, the interchange, the curved section, and the like, and the mathematical location information includes the latitude and longitude coordinates.

The service providing device 200 calculates the distance between two adjacent points on the route, that is, the specific locations using the mathematical location information (S140). The service providing device 200 calculates the distance between adjacent specific locations on each of the driver routes (S141), and calculates the distance between adjacent specific locations on each of the rider routes (S142). The service providing device 200 stores the mathematical location information of the driver route and the rider route and the distance between the specific locations calculated based on the mathematical location information in the database (DB).

Then, the service providing device 200 extracts the driver route and the rider route from the DB to calculate the matching percentage of the two routes (S150). The service providing device 200 selects the matching driver route and rider route within the given range of the carpool service use time. The service providing device 200 extracts the overlapped section where the mathematical location information on the selected driver route and the rider route, that is, the latitude/longitude coordinates of the specific locations match. The service providing device 200 calculates the length of the extracted overlapped sections. The service providing device 200 calculates the ratio of the length of the overlapped section to the total length of the driver route as the matching percentage. Further, the service providing device 200 calculates the ratio of the length of the overlapped section to the total length of the rider route as the matching percentage.

The service providing device 200 provides the carpool matching result based on the matching percentages (S160). The service providing device 200 selects the at least one carpool partner based on the matching percentage, generates the carpool partner list based on the matching percentage, and transmits the carpool partner list to the user terminal 100.

In the embodiments described above, the carpool service requesting information is simultaneously received from the driver and the rider, but the carpool service requesting information may be received from the driver or the rider.

For example, upon receiving the carpool service requesting information from the driver, the service providing device 200 selects the matching rider among the riders preregistered in the DB based on the carpool service requesting information of the driver, and provides the selected rider as the carpool partner. In one example, upon receiving the carpool service requesting information from the rider, the service providing device 200 selects the matching driver among the drivers preregistered in the DB based on the carpool service requesting information of the rider, and provides the selected driver as the carpool partner.

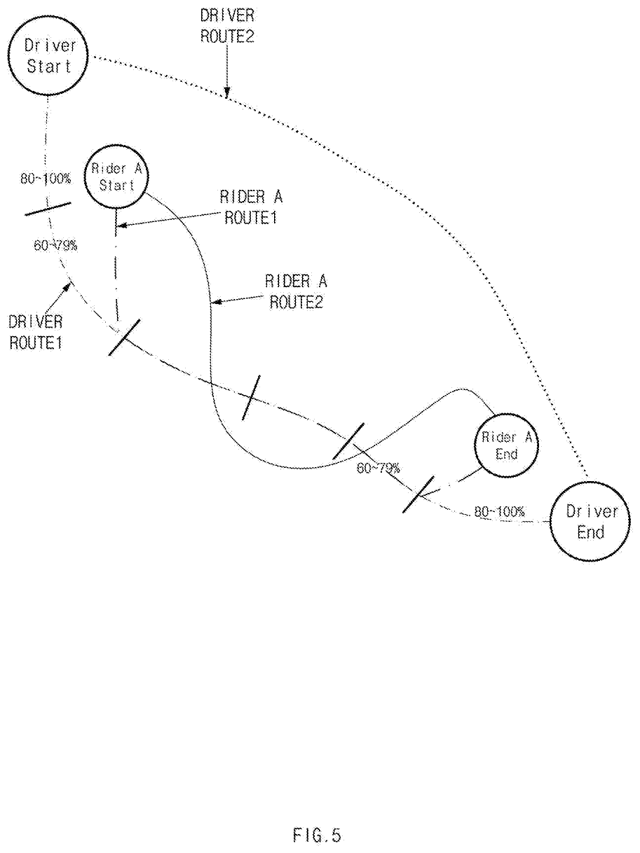

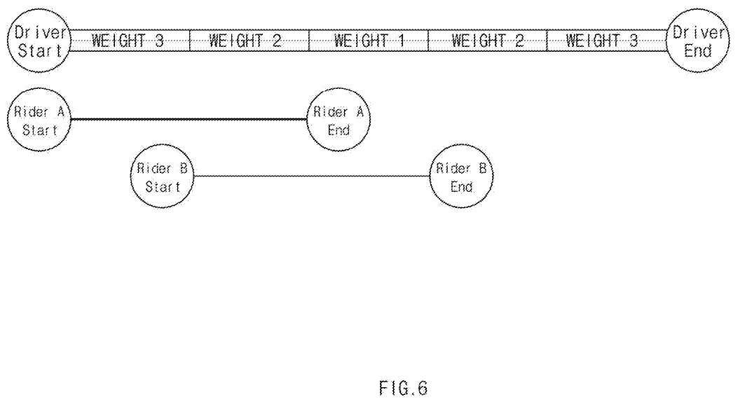

FIG. 5 and FIG. 6 show another example of a method for calculating a matching percentage according to an embodiment of the present disclosure.

In calculating the matching percentage, it is assumed that the higher each of a proximity percentage between starting points of the driver and the rider and a proximity percentage between destinations of the rider and driver, the higher a matching percentage between the driver and the rider. Under this assumption, the route may be divided into sections as shown in FIG. 5, and weights may be added to the sections respectively.

For example, the service providing device 200 may assign a weight of 3 to a section in which each of the proximity percentages between the starting points and the destinations of the driver and the rider is 80 to 100%; assign a weight of 2 to a section in which each of the proximity percentages between the starting points and the destinations of the driver and the rider is 60 to 79%; and assign a weight of 1 to a section in which each of the proximity percentages between the starting points and the destinations of the driver and the rider is less than or equal to 59%. Then, the service providing device 200 may calculate the matching percentage based on the assigned weights.

For example, as shown in FIG. 6, when one driver has two riders with the same matching percentage, the service providing device 200 selects a rider A whose route matching section has higher proximity percentages with the starting point and/or the destination of the driver as the carpool partner.

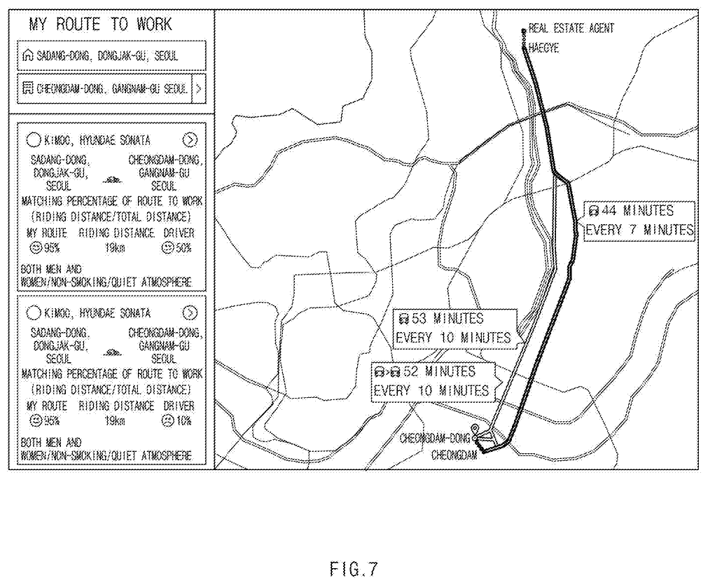

FIG. 7 shows an example of displaying a carpool partner matching result according to an embodiment of the present disclosure.

When the rider, who is the carpool service applicant inputs his/hers route to work, the service providing device 200 provides the carpool partner list based on the rider-based matching percentage. In this connection, the service providing device 200 provides a pair of the rider-based matching percentage, and the driver-based matching percentage. Therefore, the carpool service applicant may determine a probability of success of the carpool application based on a carpool service applicant-based matching percentage and a carpool partner-based matching percentage, then apply the carpool service.

According to the present disclosure, the matching ratio is calculated by converting the ratio of the overlapped length of the driver and the rider to the total length of the driver and the rider based on the latitude and longitude coordinates on the routes of the driver and the rider. Thus, a matching accuracy may be improved.

Further, according to the present disclosure, a matching parameter is selected based on a movement time range so that a carpool matching is possible even when the starting point and the destination are not adjacent.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

What is claimed is:

1. A carpool service system comprising a service providing device configured to:
receive carpool service requesting information from a user terminal;
generate at least two routes based on the carpool service requesting information; and
provide a carpool partner matching based on a first location information about each of the at least two routes and a second location information about each of one or more preregistered user routes.

2. The carpool service system of claim 1, wherein the carpool service requesting information includes a starting point, a destination, and a carpool service use time.

3. The carpool service system of claim 2, wherein the at least two routes includes at least one of an optimum route, a shortest-distance route, or a minimum-time route between the starting point and the destination.

4. The carpool service system of claim 1, wherein the service providing device is further configured to acquire a third location information of a specific location on each of the at least two routes.

5. The carpool service system of claim 4, wherein the specific location includes at least one of an intersection, an interchange, or a curved section.

6. The carpool service system of claim 4, wherein each of the first and second location information includes latitude and longitude coordinates.

7. The carpool service system of claim 6, wherein the service providing device is further configured to:
extract a section where latitude and longitude coordinates of each of the at least two routes and latitude and longitude coordinates of each of the one or more preregistered user routes match with each other; and
calculate a length of the extracted section.

8. The carpool service system of claim 7, wherein the service providing device is further configured to calculate a ratio of the length of the extracted section to a total length of each of the generated routes as a matching percentage.

9. The carpool service system of claim 8, wherein the service providing device is further configured to calculate a ratio of the length of the extracted section to a total length of each of the one or more preregistered user routes as a matching percentage.

10. The carpool service system of claim 8, wherein the service providing device is further configured to:
generate a carpool partner list based on the calculated matching percentage; and
transmit the carpool partner list to the user terminal.

11. The carpool service system of claim 10, wherein when the service providing device generates carpool partner list, the service providing device is configured to generate a pair of a carpool service applicant-based matching percentage and a carpool partner-based matching percentage.

12. The carpool service system of claim 1, wherein when the service providing device provides the carpool partner matching, the service providing device is configured to match a rider and a driver as a carpool partner, wherein each of proximity percentages between starting points of the driver and the rider and between destinations of the driver and the rider is highest among drivers and riders.

13. The carpool service system of claim 1, wherein the service providing device is further configured to:
estimate a demand to each route;
select a predetermined number of carpool service applicant routes and the one or more preregistered user routes, respectively, based on the demand; and
perform the carpool partner matching based on the selected predetermined number of carpool service applicant routes and the one or more preregistered user routes, respectively.

14. A carpool service method comprising steps of:
receiving carpool service requesting information from a user terminal;
generating at least two routes based on the carpool service requesting information;
acquiring a first location information of each of the at least two routes;
calculating a matching percentage between routes of a carpool service applicant and each of one or more preregistered users using the first location information and a second location information of a route of each of the one or more preregistered users; and
transmitting, to the user terminal, a carpool partner matching result based on the matching percentage.

15. The carpool service method of claim 14, wherein the carpool service requesting information includes a starting point, a destination, and a carpool service use time.

16. The carpool service method of claim 15, wherein the at least two routes includes at least one of an optimum route, a shortest-distance route, or a minimum-time route between the starting point and the destination.

17. The carpool service method of claim 14, wherein the step of acquiring the first location information includes:
acquiring a third location information of a specific location on each of the at least two routes; and
calculating a distance between adjacent specific locations based on the third location information.

18. The carpool service method of claim 17, wherein the specific location includes at least one of an intersection, an interchange, or a curved section.

19. The carpool service method of claim 17, wherein each of the first and second location information includes latitude and longitude coordinates.

20. The carpool service method of claim 19, wherein the step of calculating the matching percentage includes:
extracting a section where the latitude and longitude coordinates of each of the at least two routes and the route of each of the one or more preregistered users match with each other; and
calculating a length of the extracted section.

21. The carpool service method of claim 20, wherein the step of calculating the matching percentage includes:
calculating a ratio of the length of the extracted section to a total length of each of the at least two routes as a matching percentage.

22. The carpool service method of claim 20, wherein the step of calculating the matching percentage includes calculating a ratio of the length of the extracted section to a total length of the route of each of the one or more preregistered users as a matching percentage.

23. The carpool service method of claim 21, wherein the step of transmitting the carpool partner matching result to the user terminal includes:
generating a carpool partner list based on the calculated matching percentage; and
transmitting the carpool partner list to the user terminal.
